(19) United States
(12) Patent Application Publication
(10) Pub. No.: US 2015/0266166 A1
(43) Pub. Date: Sep. 24, 2015

(54) Compact Socket

(71) Applicant: Hui-Ling CHANG, TAICHUNG (TW)

(72) Inventor: Hui-Ling CHANG, TAICHUNG (TW)

(21) Appl. No.: 14/220,609

(22) Filed: Mar. 20, 2014

(51) Int. Cl. B25B 13/06

(52) U.S. Cl. CPC B25B 13/06

(57) ABSTRACT

A compact socket includes an input portion formed at an end and an output portion formed at an opposite end. The input portion is formed with a non-circular bore and a circular bore in communication with the non-circular bore. The output portion is formed with a non-circular bore in communication with the circular bore.

### BACKGROUND OF INVENTION

1. Field of Invention

The present invention relates to sockets for use in a wrench and, more particularly, to a compact socket for use in a limited space.

2. Related Prior Art

Referring to FIGS. 1 through 3, a conventional socket 10 includes an intermediate portion formed between an input portion and an output portion. The input portion of the socket 10 is made with a square bore 12. The output portion of the socket 10 is made with a hexagonal bore 16. The intermediate portion of the socket 10 is made with a circular bore 14 in communication with the square bore 12 at an end and in communication with the hexagonal bore 16 at an opposite end. In use, a square insert of a manual, pneumatic or electric tool (not shown) is inserted in the square bore 12, and a nut or a hexagonal head of threaded bolt is inserted in the hexagonal bore 16. Thus, the nut or threaded bolt can be driven by the manual, pneumatic or electric tool via the socket 10.

The diameter D of the circumscribed circle of the square bore 12 is substantially identical close to the diameter D of the circumscribed circle of the hexagonal bore 16 but larger than the diameter of the circular bore 14. The height H of the socket 10 is the sum of the depth L of the square bore 12, the depth h of the hexagonal bore 16 and the depth S of the circular bore 14. A ratio of the height H over the width W is about 13:9. A ratio of the depth L over the depth h is about 4:3. A ratio of the width W over the depth h is about 2:1. A ratio of the height H over the diameter D is about 5:3. For example, the depth L is 11.6 mm, the depth h is 9.7 mm, and the depth S is 4.6 mm where the height H is 25.9 mm, the width W is 18.4 mm, and the diameter D is 15.1 mm.

Therefore, the present invention is intended to obviate or at least alleviate the problems encountered in prior art.

### SUMMARY OF INVENTION

It is the primary objective of the present invention to provide a compact socket for use in a limited space.

To achieve the foregoing objective, the compact socket includes an input portion formed at an end and an output portion formed at an opposite end. The input portion is formed with a non-circular bore and a circular bore in communication with the non-circular bore. The output portion is formed with a non-circular bore in communication with the circular bore.

Other objectives, advantages and features of the present invention will be apparent from the following description referring to the attached drawings.

### BRIEF DESCRIPTION OF DRAWINGS

The present invention will be described via detailed illustration of two embodiments in view of the prior art referring to the drawings wherein:

FIG. 1 is a top view of a conventional socket;

FIG. 2 is a cross-sectional view of the socket shown in FIG. 1;

FIG. 3 is a bottom view of the socket shown in FIG. 1;

FIG. 4 is a top view of a compact socket according to the first embodiment of the present invention;

FIG. 5 is a cross-sectional view of the compact socket illustrated in FIG. 4;

FIG. 6 is a bottom view of the compact socket shown in FIG. 4; and

FIG. 7 is a cross-sectional view of a compact socket according to the second embodiment of the present invention.

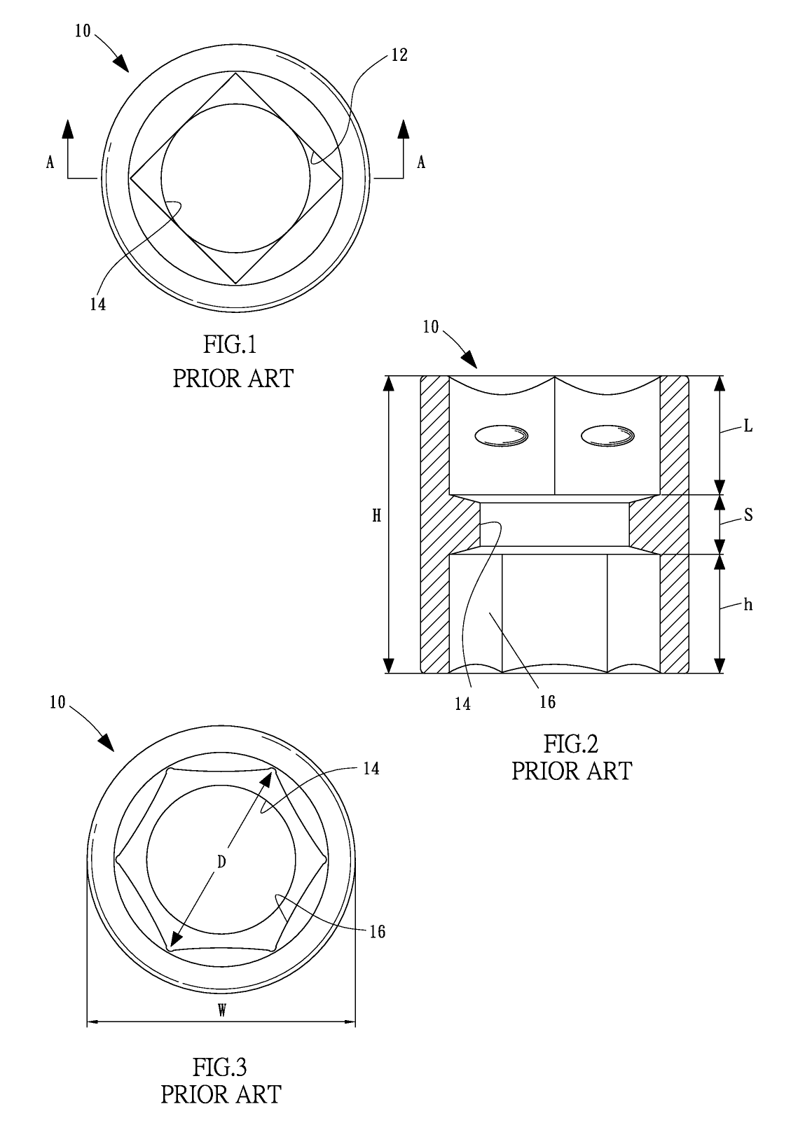

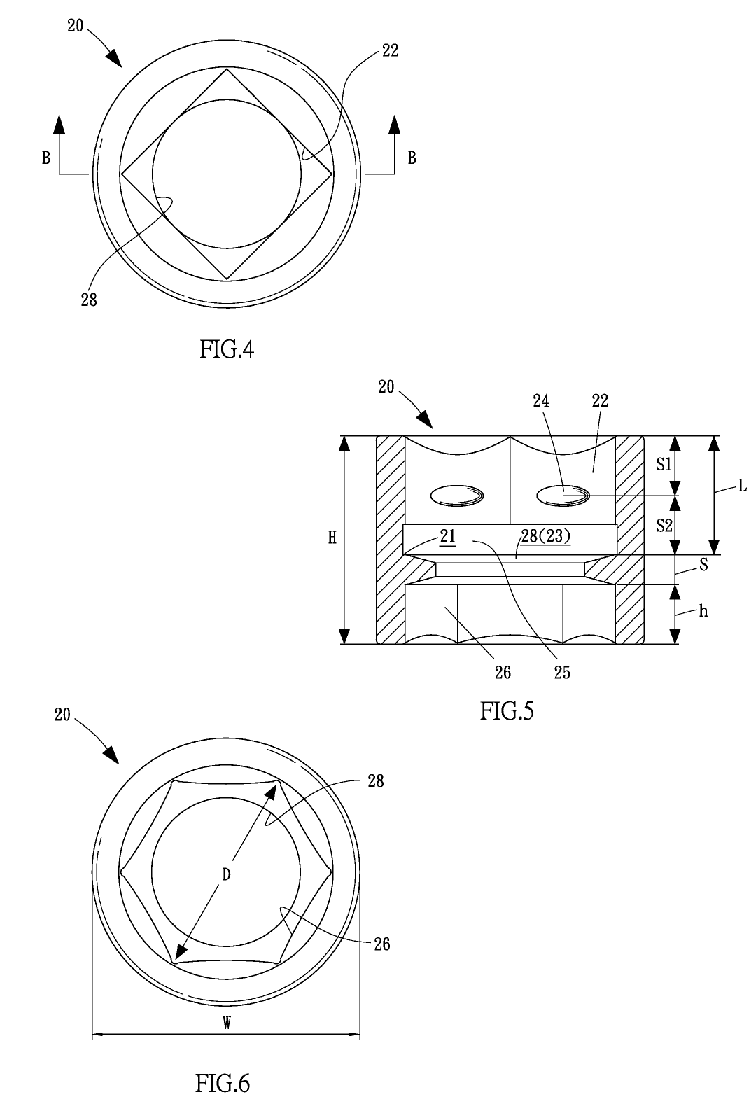

### DETAILED DESCRIPTION OF EMBODIMENTS

Referring to FIGS. 4 through 6, there is shown a socket 20 according to a first embodiment of the present invention. The socket 20 includes an intermediate portion formed between an input portion and an output portion.

The input portion of the socket 20 is made with a non-circular bore 22 and a circular bore 25. The non-circular bore 22 is preferably a square bore. The square bore 22 is defined by four facets each including a recess 24. The circular bore 25 is in communication with the square bore 22.

The output portion of the socket 10 includes a non-circular bore 26 that is preferably a hexagonal bore.

The intermediate portion of the socket 20 includes a circular bore 28 in communication with the circular bore 25 at an end and in communication with the hexagonal bore 26 at an opposite end. The circular bore 25 includes a middle section 23 between two terminal sections 21. The diameter of the middle section 23 of the circular bore 25 is constant. The diameter of each of the terminal sections 21 of the circular bore 25 gets larger in a direction away from the middle section 23 of the circular bore 25.

In use, a square insert of a manual, pneumatic or electric tool (not shown) is inserted in the square bore 22. A detent attached to the square insert is inserted in one of the recesses 24 so that the socket 20 can be kept on the handle. The detent is preferably a spring-biased ball. A nut or a hexagonal head of threaded bolt is inserted in the hexagonal bore 26. Thus, the nut or threaded bolt can be driven by the manual, pneumatic or electric tool via the socket 20.

The diameter of circular bore 25 is larger than the diameter of the circumscribed circle of the square bore 22 and the diameter of the circumscribed circle of the hexagonal bore 26 in the first embodiment. The diameter of circular bore 25 can be smaller than the diameter of the circumscribed circle of the square bore 22 and the diameter of the circumscribed circle of the hexagonal bore 26 in another embodiment. The diameter of circular bore 25 is within 1.5 mm larger or smaller than the diameter of the circumscribed circle of the square bore 22 and/or the diameter of the circumscribed circle of the hexagonal bore 26.

There is a length S1 of the center of each of the recesses 24 to an end of the input portion of the socket 20. There is a length S2 of the center of each of the recesses 24 to an opposite end of the input portion of the socket 20. The length L of the input portion of the socket 20 is the sum of the lengths S1 and S2.

The height H of the socket 20 is the sum of the length L of the input portion of the socket 20, the depth h of the hexagonal bore 26 and the depth S of the circular bore 28. That is, the height H of the socket 20 is the sum of the lengths S1 and S2 and the depths h and S.

The ratio of the length L over the depth h is 1.5:1 to 2.5:1. For example, the ratio of the length L over the depth h is about 2:1 where the length L is 11 mm while the depth h is 6 mm.

The ratio of the depth h over the depth S is about 2.5:1 to 6.5:1. For example, the ratio of the depth h over the depth S is about 3:1 where the depth h is 6 mm and the depth S is 2 mm.

The length L of the input portion of the socket 20 is about the same as that of the prior art while the depths h and S are smaller than that of the prior art. Hence, the total length of the socket 20 is smaller than that of the prior art. The socket 20 is particular useful in a limited space. The ratio of the width W of the socket 20 over the depth h is about 2.5:1 to 3.5:1 and preferably 3:1.

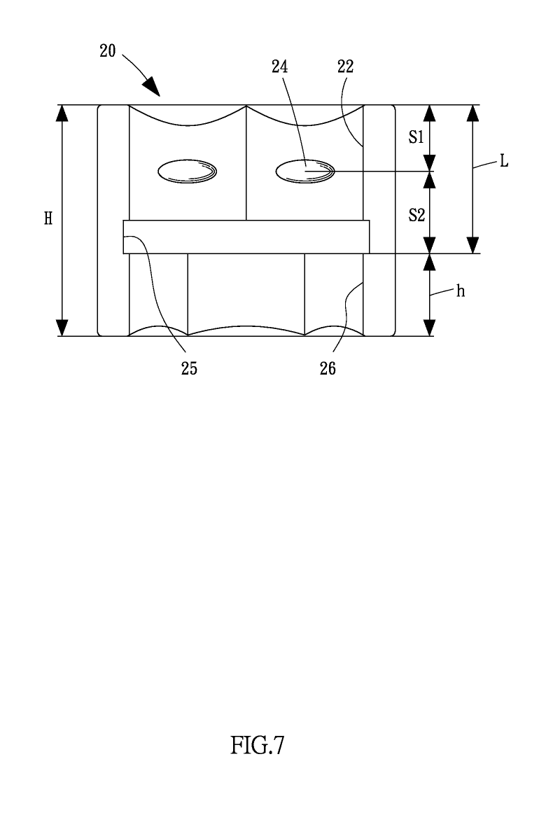

Referring to FIG. 7, there is a socket according to a second embodiment of the present invention. The second embodiment is like the first embodiment except saving the intermediate portion. That is, the second embodiment is like the first embodiment except saving the circular bore 28.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A compact socket including:
an input portion formed with a non-circular bore and a circular bore in communication with the non-circular bore; and
an output portion formed with a non-circular bore in communication with the circular bore.

2. The compact socket according to claim 1, wherein the diameter of the circular bore is within 1.5 mm different from the diameter of a circumscribed circle of the non-circular bore of the input portion.

3. The compact socket according to claim 2, wherein the diameter of the circular bore is larger than the diameter of the circumscribed circle of the non-circular bore of the input portion.

4. The compact socket according to claim 2, wherein the diameter of the circular bore is smaller than the diameter of the circumscribed circle of the non-circular bore of the input portion.

5. The compact socket according to claim 1, wherein the diameter of the circular bore is within 1.5 mm different from the diameter of a circumscribed circle of the non-circular bore of the output portion.

6. The compact socket according to claim 5, wherein the diameter of the circular bore is larger than the diameter of the circumscribed circle of the non-circular bore of the output portion.

7. The compact socket according to claim 1, wherein the diameter of the circular bore is smaller than the diameter of the circumscribed circle of the non-circular bore of the output portion.
